(19) United States
(12) Patent Application Publication
(10) Pub. No.: US 2015/0132593 A1
(43) Pub. Date: May 14, 2015

(54) CURL RESISTANT BARRIER FILMS

(71) Applicant: NOVA Chemicals (International) S.A., Fribourg (CH)

(72) Inventors: Nitin Borse, Calgary (CA); Norman Dorien Joseph Aubee, Okotoks (CA); Daniel Ward, Mainesville, OH (US)

(73) Assignee: NOVA Chemicals (International) S.A., Fribourg (CH)

(21) Appl. No.: 14/406,348

(22) PCT Filed: Jun. 11, 2013
(86) PCT No.: PCT/CA2013/000555

§ 371 Date: Dec. 8, 2014

Related U.S. Application Data
(60) Provisional application No. 61/668,293, filed on Jul. 5, 2012.

(51) Int. Cl. B32B 27/32; B32B 27/08; B32B 27/30

(52) U.S. Cl. CPC B32B 27/32; B32B 27/306; B32B 27/08; B32B 2250/40; B32B 2439/70; B32B 2307/7244; B32B 2307/7246; B32B 2307/734
USPC 428/516; 428/523

(57) ABSTRACT

Multilayer “barrier” films which have excellent Water Vapor Transmission Rate (WVTR) performance are prepared using a core layer which comprises a blend of from 92 to 60 weight % of nucleated HDPE and from 8 to 40 weight % LDPE. The films are suitable for the preparation of packages for dry foods such as crackers and breakfast cereals.

### TECHNICAL FIELD

This invention relates to new designs for multilayer plastic films having high barrier properties.

### BACKGROUND ART

Plastic films having gas barrier properties are widely used in packaging for dry foods. The films should have a low Water Vapor Transmission Rate (WVTR) and a low Oxygen Transmission Rate (OTR). Aroma barrier is also desirable.

The paper packaging that was originally used in these applications was partially replaced by cellophane, but cellophane is expensive and difficult to process.

Barrier films prepared from high density polyethylene (HDPE) offer an alternative to paper or cellophane. HDPE films offer a good balance between cost and performance. However, when additional barrier and/or toughness is required, it is known to prepare multilayer films which contain layers made of more expensive barrier resins (such as ethylene-vinyl alcohol (EVOH); polyamide (nylon); polyesters; ethylene-vinyl acetate (EVA); or polyvinyldiene chloride (PVDC)) and/or layers of stronger/tougher resins such as ionomers or linear low density linear polyethylenes (“LLDPE”). Sealant layers made from EVA, ionomer, “high pressure low density polyethylene” (“LDPE”) or plastomers are also employed in multilayer structures.

The expensive barrier resins listed above (polyamide, EVOH, polyesters and PVDC) tend to be more polar than HDPE. This can cause adhesion problems between layers of polar and non-polar resins in multilayer film structures. Accordingly, “tie layers” or adhesives may be used between the layers to reduce the probability that the layers separate from one another.

Monolayer HDPE films are inexpensive, easy to prepare and offer moderate resistance to water vapor and oxygen transmission. Moreover, it is simple to provide increased barrier properties by just increasing the thickness of the film. However, the mechanical properties (such as tear strength and impact strength) and sealing properties of HDPE film are comparatively low so multilayer films are widely used.

Thus, the design of barrier films involves a cost/benefit analysis—with the low cost of HDPE resin being balanced against the better performance of the more expensive, polar resins. Another way to lower the cost of the film is to simply use less material—by manufacturing a thinner or “down gauged” film.

Examples of multilayer barrier films that use HDPE are disclosed in U.S. Pat. No. 4,188,441 (Cook); U.S. Pat. No. 4,254,169 (Schroeder); and U.S. Pat. No. 6,045,882 (Sandford) and our previously published Canadian patent application CA 2,594,472 (Aubee et al.).

### DISCLOSURE OF INVENTION

The present invention provides:

a barrier film comprising a core layer and two skin layers, wherein said core layer consists essentially of a blend of:

a) from 60 to 92 weight % of a nucleated high density polyethylene resin; and

b) 40 to 8 weight % of high pressure, low density polyethylene.

It will be appreciated by those skilled in the art of producing multilayer films that these films can roll up upon themselves or “curl.” One generally accepted theory for the mechanism that causes curl is that “differential shrinkage”—i.e. the tendency for one layer to shrink at a different rate from the others—leads to curl. This theory has been discussed in the literature and is summarized in two papers that were presented at the annual conference of the Society of Plastics Engineers (“SPE”) in 2002 (ref: Morris; SPE (2002), 60th (Vol 1), 40-46 and Morris; SPE (2002), 60th (Vol 1), 32-39).

Two factors that may influence the degree of differential shrinkage are:
1) The materials of construction (for example, if a skin layer is made from a material that shrinks more than the material used for an inner layer; and
2) Process conditions: for example, if a freshly fabricated film is cooled on only one side of the film (such as the interior of a blown film), the rate of shrinkage on that side can be different from the rate of shrinkage on the “outside” of the blown film bubble.

These problems can be increased when a nucleating agent is present in the material used in one layer of a multilayer film because in general, the addition of a nucleating agent will cause a polymeric material to shrink more upon cooling (in comparison to the rate of shrinkage for the same polymer under the same cooling conditions in the absence of the nucleating agent). To some extent, this problem can be mitigated by using the same nucleated polymer in the core layer and at least one of the skin layers. An example of this type of film design is disclosed in Table 1 of CA 2,594,472. We have now discovered another design alternative that utilizes a blend of HDPE and LDPE in the core layer of a multilayer film.

### BEST MODE FOR CARRYING OUT THE INVENTION

### A. HDPE

Preferred HDPE for use in the films of this invention has a density of from 0.950 grams per cubic centimeter (g/cc) to about 0.970 g/cc as determined by ASTM D1505. Preferred HDPE also has a density of greater than 0.955 g/cc and the most preferred HDPE is a homopolymer of ethylene having a density of greater than 0.958 g/cc. Preferred HDPE is further characterized by having a melt index, I₂, of from 0.3 to 20 grams per 10 minutes, especially from 0.5 to 10 grams per 10 minutes (as measured by ASTM D1238 at 190° C. with a 2.16 kg load and commonly referred to as “I₂”)

The molecular weight distribution of the HDPE [which is determined by dividing the weight average molecular weight (Mw) by number average molecular weight (Mn), where Mw and Mn are determined by gel permeation chromatography, according to ASTM D 6474-99] is preferably from 2 to 20, especially from 2 to 10.

A highly preferred HDPE is prepared by a solution polymerization process using two reactors that operate under different polymerization conditions. This provides a uniform, in situ blend of two HDPE blend components. An example of this process is described in U.S. Pat. No. 7,737,220 (Swabey et al.), the disclosure of which is incorporated herein by reference. The use of the “dual reactor” process also facilitates the preparation of blends which have very different melt index values. It is highly preferred to use a blend (prepared by the dual reactor process) in which the first HDPE blend component has a melt index (I₂) value of less than 0.5 g/10 minutes and the second HDPE blend component has an I₂ value of greater than 100 g/10 minutes. The amount of the first HDPE blend component of these blends is preferably from 40 to 60 weight % (with the second blend component making the balance to 100 weight %). The overall HDPE blend composition preferably has a MWD (Mw/Mn) of from 3 to 20.

### B. Nucleating Agents

The term nucleating agent, as used herein, is meant to convey its conventional meaning to those skilled in the art of preparing nucleated polyolefin compositions, namely an additive that changes the crystallization behavior of a polymer as the polymer melt is cooled.

Nucleating agents are widely used to prepare polypropylene molding compositions and to improve the molding characteristics of polyethylene terephthalate (PET).

A review of nucleating agents is provided in U.S. Pat. Nos. 5,981,636; 6,466,551 and 6,559,971, the disclosures of which are incorporated herein by reference.

The multilayer films of this invention comprise a core layer which must contain “nucleated HDPE”. As used here, the term “nucleated HDPE” is meant to convey its plain meaning, namely HDPE (as described in Part A above) which contains a nucleating agent (as described in Part B).

The nucleating agent is preferably well dispersed in the HDPE. The amount of nucleating agent used is preferably quite small—from 100 to 3000 parts per million by weight (based on the weight of the polyethylene) so it will be appreciated by those skilled in the art that some care must be taken to ensure that the nucleating agent is well dispersed. It is preferred to add the nucleating agent in finely divided form (less than 50 microns, especially less than 10 microns) to the polyethylene to facilitate mixing. An alternative to a “physical blend” (i.e. a mixture of the nucleating agent and the resin in solid form) is the use of a “masterbatch” of the nucleator (where the term “masterbatch” refers to the practice of first melt mixing the additive—the nucleator, in this case—with a small amount of HDPE resin—then melt mixing the “masterbatch” with the remaining bulk of the HDPE resin).

It is especially preferred to include a metal stearate (such as zinc or calcium stearate) in a 1/2 to 2/1 weight ratio with respect to the nucleating agent. While not wishing to be by theory, it is believed that the stearate may improve the dispersion of the nucleating agent.

Examples of nucleating agents which may be suitable for use in the present invention include the cyclic organic structures disclosed in U.S. Pat. No. 5,981,636 (and salts thereof, such as disodium bicyclo [2.2.1] heptene dicarboxylate); the saturated versions of the structures disclosed in U.S. Pat. No. 5,981,636 (as disclosed in U.S. Pat. No. 6,465,551; Zhao et al., to Milliken); zinc glycerolate; the salts of certain cyclic dicarboxylic acids having a hexahydrophtalic acid structure (or “HHPA” structure) as disclosed in U.S. Pat. No. 6,559,971 (Dotson et al., to Milliken); and phosphate esters, such as those disclosed in U.S. Pat. No. 5,342,868 and those sold under the trade names NA-11 and NA-21 by Asahi Denka Kogyo. Preferred barrier nucleating agents are cyclic dicarboxylates and the salts thereof, especially the divalent metal or metalloid salts, (particularly, calcium salts) of the HHPA structures disclosed in U.S. Pat. No. 6,559,971. For clarity, the HHPA structure generally comprises a ring structure with six carbon atoms in the ring and two carboxylic acid groups which are substituents on adjacent atoms of the ring structure. The other four carbon atoms in the ring may be substituted, as disclosed in U.S. Pat. No. 6,559,971. A preferred example is I,2-cyclohexanedicarboxylic acid, calcium salt (CAS registry number 491589-22-1).

### C. LDPE

The core layer of the films of this invention is prepared from a blend of a) “nucleated HDPE” and b) high pressure, low density polyethylene (or “LDPE”).

The relative amounts of nucleated HDPE and LDPE in the core layer are from 5 to 40 weight % LDPE with 95 to 60 weight % nucleated HDPE (especially from 8 to 20 weight % LDPE with 92 to 80 weight % nucleated HDPE).

The LDPE preferably has a melt index, I₂, of from 0.5 to 3 grams per 10 minutes (as measured by ASTM D1238 at 190° C. using a 2.16 kg weight) and a density of from 0.917 to 0.922 grams per cubic centimeter (g/cc).

### D. Film Structure

A three layer film structure may be described as layers A-B-C, where the internal layer B (the “core” layer) is sandwiched between two external “skin” layers A and C. In many multilayer films, one (or both) of the skin layers is made from a resin which provides good seal strength and is typically referred to as a sealant layer.

Table 1 illustrates a comparative three layer film structure (which was first disclosed in CA 2,594,472, Aubee et al.). As shown in the examples, this type of structure can provide very good curl resistance. It contains nucleated HDPE in both of the core layer and a skin layer (with a sealant resin forming the other skin layer). The sealant resin is LDPE (as described in Part C, above).

However, when the skin layer is replaced with other resins—such as linear low density polyethylene (“LLDPE”); or HDPE that does not contain a nucleating agent, then some “curl” is often observed.

Five, seven and nine layer film structures are also within the scope of this invention. As will be appreciated by those skilled in the art, it is known to prepare barrier films with excellent WVTR performance by using a core layer of nylon and skin layers made from conventional HDPE (or LLDPE) and conventional sealant resins. These structures generally require “tie layers” to prevent separation of the nylon core layer from the extra layers. For some applications, the three layer structures described above may be used instead of the 5 layer structures with a nylon (polyamide) core.

In preferred 5 layer structures according to the present invention, the (nucleated) blend of HDPEs in the core layer is in direct contact with layers made from a lower density polyethylene (e.g. LLDPE) to improve the mechanical and tear properties of the five layer structure. The two “skin layers” of these structures may be made from polyethylene, polypropylene, cyclic olefin copolymers—with one of the skin layers most preferably being made from a sealant resin.

Seven layer structures allow for further design flexibility. In a preferred seven layer structure, one of the layers consist of nylon (polyamide)—or an alternative polar resin having a desired barrier property—and two tie layers which incorporate the nylon layer into the structure. Nylon is comparatively expensive and difficult to use. The 7 layer structures of this invention allow less of the nylon to be used (because of the excellent WVTR performance of the core layer of this invention). Curl behavior is represented on a qualitative scale from 1 to 5. MD curl and TD curl refer to the tendency for the film to curl in the Machine Direction (MD) and Transverse Direction (TD) respectively. A value of “0” indicates no curl and a value of 5 indicates severe curl. A summary of different three layer structures that we have tested is shown in Table 2.

The core layer of the multilayer films is preferably from 40 to 70 weight % of thin films (having a thickness of less than 2 mils). For all films, it is preferred that the core layer is at least 0.5 mils thick.

TABLE 1
(Comparative) Structure from Aubee et al.; CA 2,594,472

| | Layer | | | |
|---|---|---|---|---|
| | | | C (sealant | |
| | A | B | LDPE) | WVTR |
| Film | [wt %] | [wt %] | [wt %] | g/100 in²/day |
| 1 | n.HDPE 15 | n.HDPE 70 | 15 | 0.1339 |
| 2 | n.HDPE 30 | n.HDPE 55 | 15 | 0.1563 |

The term n.HDPE (used in the core layer and skin layer A) identifies an HDPE containing a nucleating agent.

### E. Other Additives

The polymers used to prepare the films of this invention may also contain other conventional additives, especially (1) primary antioxidants (such as hindered phenols, including vitamin E); (2) secondary antioxidants (especially phosphites and phosphonites); and (3) process aids (especially fluoroelastomer and/or polyethylene glycol process aid).

### F. Film Extrusion Process

Blown Film Process

The extrusion-blown film process is a well known process for the preparation of multilayer plastic film. The process employs multiple extruders which heat, melt and convey the molten plastics and forces them through multiple annular dies. Typical extrusion temperatures are from 330 to 500° F., especially 350 to 460° F.

The polyethylene film is drawn from the die and formed into a tube shape and eventually passed through a pair of draw or nip rollers. Internal compressed air is then introduced from the mandrel causing the tube to increase in diameter forming a “bubble” of the desired size. Thus, the blown film is stretched in two directions, namely in the axial direction (by the use of forced air which “blows out” the diameter of the bubble) and in the lengthwise direction of the bubble (by the action of a winding element which pulls the bubble through the machinery). External air is also introduced around the bubble circumference to cool the melt as it exits the die. Film width is varied by introducing more or less internal air into the bubble thus increasing or decreasing the bubble size. Film thickness is controlled primarily by increasing or decreasing the speed of the draw roll or nip roll to control the draw-down rate. Preferred multilayer films according to this invention have a total thickness of from 1 to 4 mils.

The bubble is then collapsed into two doubled layers of film immediately after passing through the draw or nip rolls. The cooled film can then be processed further by cutting or sealing to produce a variety of consumer products. While not wishing to be bound by theory, it is generally believed by those skilled in the art of manufacturing blown films that the physical properties of the finished films are influenced by both the molecular structure of the polyethylene and by the processing conditions. For example, the processing conditions are thought to influence the degree of molecular orientation (in both the machine direction and the axial or cross direction).

A balance of “machine direction” (“MD”) and “transverse direction” (“TD”—which is perpendicular to MD) molecular orientation is generally considered most desirable for key properties associated with the invention (for example, Dart Impact strength, Machine Direction and Transverse Direction tear properties).

Thus, it is recognized that these stretching forces on the “bubble” can affect the physical properties of the finished film. In particular, it is known that the “blow up ratio” (i.e. the ratio of the diameter of the blown bubble to the diameter of the annular die) can have a significant effect upon the dart impact strength and tear strength of the finished film.

Further details are provided in the following examples.

### EXAMPLES

### Example 1

The films were made on a three layer coextrusion film line manufactured by Brampton Engineering. Three layer films having a total thickness of 2 mils were prepared using a blow up ratio (BUR) of 2/1.

The “sealant” layer (i.e. the skin layers identified as layer C in Table 2) was prepared from a conventional high pressure, low density polyethylene homopolymer having a melt index of about 2 grams/10 minutes unless otherwise indicated. Such low density homopolymers are widely available items of commerce and typically have a density of from about 0.915 to 0.930 g/cc.

Water Vapor Transmission Rate (“VVVTR”, expressed as grams of water vapor transmitted per 100 square inches of film per day at a specified film thickness (mils), or g/100 in²/day) was measured in accordance with ASTM F1249-90 with a MOCON permatron developed by Modern Controls Inc. at conditions of 100° F. (37.8° C.) and 100% relative humidity.

As shown in Table 2, some curl was observed when the first skin layer was prepared with LLDPE or HDPE. However, this problem could be mitigated by the addition of nucleated HDPE to the skin layer (i.e. to form a blend of nucleated and non-nucleated HDPE or a blend of LLDPE with nucleated HDPE). The use of these blends in the skin layer was observed to produce films having a small amount of “curl” (and such films would be satisfactory for many end uses/applications).

Surprisingly, the addition of some LDPE to the core layer was observed to produce multilayer films with little or no curl (see inventive films 16-22). That is, the use of a core layer that consisted of a blend of nucleated HDPE with LDPE was observed to produce “flat” film.

TABLE 2

| | Layer | | | | |
|---|---|---|---|---|---|
| | A | B | C | MD | TD |
| Film | wt % | wt % | wt % | curl | curl |
| 1-C | 15% | 50% | 35% | 2 | 4 |
| | LLDPE-A | LLDPE-A | LDPE-A | | |
| 2-C | 35% | 50% | 15% | 4 | 1 |
| | HDPE-A | n.HDPE-1 | LDPE-A | | |
| 3-C | 35% | 50% | 15% | 5 | 0 |
| | HDPE-A | 70% n.HDPE-1 + | LDPE-A | | |
| | | 30% 19C | | | |
| 4-C | 35% | 50% | 15% | 0 | 0 |
| | HDPE-A | 70% n.HDPE-1 + | LDPE-A | | |
| | | 30 LLDPE-A | | | |
| 5-C | 15% | 50% | 35% | 5 | 2 |
| | LDPE-2 | n.HDPE-1 | n.HDPE | | |
| 6-C | 35% | 50% | 15% | 5 | 1 |
| | n.HDPE-1 | n.HDPE-1 | LDPE-A | | |
| 7-C | 35% | 50% | 15% | 5 | 3 |
| | 70% HDPE-A + | n.HDPE-1 | LDPE-A | | |
| | 30% LLDPE-A | | | | |
| 8-C | 35% | 50% | 15% | 3.5 | 1 |
| | 70% HDPE-A + | 70% n.HDPE-1 + | LDPE-A | | |
| | 30% LLDPE-A | 30% LLDPE-A | | | |
| 9-C | 35% | 50% | 15% | 0 | 0 |
| | HDPE-A | 70% n.HDPE-1 + | LDPE-A | | |
| | | 30% LLDPE-A | | | |
| 10-C | 35% | 50% | 15% | 0 | 0 |
| | HDPE-A | 85% n.HDPE-1 + | LDPE-A | | |
| | | 15% LLDPE-A | | | |
| 11-C | 35% | 50% | 15% | 5 | 1 |
| | HDPE-A | n.HDPE-1 | LDPE-A | | |
| 12-C | 35% | 50% | 15% | 0 | 0 |
| | n. HDPE-A | n.HDPE-1 | LDPE-A | | |
| 13-C | 35% | 50% | 15% | 5 | 1 |
| | HDPE-A | 70% n.HDPE-1 + | LDPE-A | | |
| | | 30% 19C | | | |
| 14-C | 35% | 50% | 15% | 0 | 0 |
| | 69% 19C + | 70% n.HDPE-1 + | LDPE-A | | |
| | 30% n.HDPE-1 | 30% HDPE-A | | | |
| 15-C | 35% | 50% | 15% | 0 | 0 |
| | 70% HDPE-A + | n.HDPE-1 | LDPE-A | | |
| | 30% n.HDPE-1 | | | | |
| 16 | 35% | 50% | 15% | 0 | 0 |
| | HDPE-A | 70% n.HDPE-1 + | LDPE-A | | |
| | | 30% LDPE-A | | | |
| 17 | 35% | 50% | 15% | 1 | 1 |
| | 70% HDPE-A + | 70% n.HDPE-1 + | LDPE-A | | |
| | 30% LDPE-A | 30% LDPE-A | | | |
| 18 | 35% | 50% | 15% | 5 | 3 |
| | 70% HDPE-A + | n.HDPE-1 | LDPE-A | | |
| | 30% LDPE-A | | | | |
| 19 | 35% | 50% | 15% | 5 | 2 |
| | HDPE-A | n.HDPE-1 | LDPE-A | | |
| 20-C | 35% | 50% | 15% | 4 | 1 |
| | HDPE-A | 95% n.HDPE-1 + | LDPE-A | | |
| | | 5% LDPE-A | | | |
| 22 | 35% | 50% | 15% | 0 | 0 |
| | HDPE-A | 70% n.HDPE-1 + | LDPE-A | | |
| | | 30% LDPE-A | | | |
| 23-C | 35% | 50% | 15% | 0.5 | 0.5 |
| | n.HDPE-1 + | n.HDPE-1 | LDPE-A | | |
| | 1% 1150 | | | | |
| 24-C | 35% | 50% | 15% | 5 | 3 |
| | HDPE-A | n.HDPE-1 | LDPE-A | | |
| 25-C | 15% | 50% | 35% | 5 | 0.5 |
| | LDPE-2 | n.HDPE-1 | HDPE-A | | |
| 26-C | 15% | 50% | 35% | 0 | 0 |
| | LDPE-2 | 70% n.HDPE-1 + | 30% n.HDPE-1, | | |
| | | 30% HDPE-A | 70% HDPE-A | | |
| 27-C | 35% | 50% | 15% | 5 | 2 |
| | HDPE-A | n.HDPE-1 | LDPE-A | | |
| 28-C | 35% | 50% | 15% | 5 | 1 |
| | HDPE-C | n.HDPE-1 | LDPE-A | | |
| 29-C | 35% | 50% | 15% | 5 | 2 |
| | HDPE-A | n.HDPE-1 | LDPE-A | | |

Brief description of the polyethylene resins used to prepare the films of Table 2 are provided below:
LLDPE—A: an ethylene/octene copolymer having a melt index (I₂) of 0.65 g/10 minutes and a density of 0.916 g/cc.
HDPE—A: an ethylene homopolymer having a melt index (I₂) of 0.95 g/10 minutes and a density of 0.958 g/cc.
n.HDPE-1: a nucleated HDPE having a density of 1.2 g/10 minutes and a density of 0.966 g/cc.
n.HDPE: homopolymer HDPE-A (above)+nucleating agent
LDPE-A: a high pressure, low density ethylene homopolymer having a melt index (I₂) of 0.75 g/10 minutes and a density of 0.919 g/cc.
LDPE-2: a high pressure, low density ethylene homopolymer having a melt index (I₂) of 2.2 g/10 minutes and a density of 0.923 g/cc.
HDPE-B: an ethylene homopolymer having a melt index (I₂) of 0.85 g/10 minutes and a density of 0.958 g/cc.
HDPE-C: an ethylene homopolymer having a melt index (I₂) of 2.8 g/10 minutes and a density of 0.958 g/cc.
-C: comparative example
A fluoroelastomer process (of the type that is conventionally used to reduce melt fracture) was added to skin layer A of the following films: 6, 14, 15, 17, 18, and 28.

### INDUSTRIAL APPLICABILITY

The multilayer films of this invention are suitable for the preparation of a wide variety of packages. They are especially suitable for the preparation of packages for “dry” foods such as crackers and breakfast cereals.

1. A barrier film comprising a core layer and two skin layers, wherein said core layer consists essentially of a blend of:
a) from about 92 to about 60 weight % of a nucleated high density polyethylene resin; and
b) from about 8 to about 40 weight % of high pressure, low density polyethylene.

2. The barrier film of claim 1 wherein said high pressure, low density polyethylene has a melt index, I₂, of from about 0.5 to about 3 grams per 10 minutes and a density of from about 0.917 to about 0.922 g/cc.

3. The barrier resin of claim 1 wherein said nucleated high density polyethylene has a melt index, I₂, of from about 0.3 to about 20 grams/10 minutes.

4. The barrier resin of claim 1 wherein at least one of said skin layers comprises a sealant resin selected from the group consisting of LDPE, EVA, ionomer and polybutylene.

5. The barrier film of claim 1 which consists of 5 layers.

6. The barrier film of claim 1 which consists of 7 layers.

7. The barrier film of claim 1 which consists of 9 layers.

8. The barrier film of claim 1 wherein said nucleated HDPE contains a nucleating agent that is a salt of a dicarboxylic acid.

9. The barrier film of claim 8 wherein said dicarboxylic acid is a cyclic dicarboxylic acid having a hexahydrophtalic structure.
